(19) United States
(12) Patent Application Publication
(10) Pub. No.: US 2026/0269478 A1
(43) Pub. Date: Sep. 10, 2026

(54) ANTENNA DEVICE, ANTENNA MODULE, AND COMMUNICATION DEVICE

(71) Applicant: Murata Manufacturing Co., Ltd., Nagaokakyo-shi (JP)

(72) Inventor: Ryo KOMURA, Nagaokakyo-shi (JP)

(73) Assignee: Murata Manufacturing Co., Ltd., Nagaokakyo-shi (JP)

(21) Appl. No.: 19/660,551

(22) Filed: Apr. 28, 2026

Related U.S. Application Data
(63) Continuation of application No. PCT/JP2025/002234, filed on Jan. 24, 2025.

(30) Foreign Application Priority Data
Jan. 29, 2024 (JP) 2024-011103

(51) Int. Cl. H01Q 9/04; H01Q 9/16

(52) U.S. Cl. CPC H01Q 9/0414; H01Q 9/16

(57) ABSTRACT

An antenna device includes a substrate with laminated dielectric layers, at least one first radiating element in or on the substrate, at least one second radiating element adjacent to the at least one first radiating element in a first direction, a ground electrode opposite the at least one first radiating element and the at least one second radiating element, and at least one peripheral electrode between the at least one first radiating element and the ground electrode, the at least one peripheral electrode being electrically connected to the ground electrode and to the at least one second radiating element, wherein the at least one second radiating element includes first and second end portions opposite each other, a median line of the substrate extends along the first direction, and the first end portion is an open-circuited end that is closer to the median line than the second end portion is.

### CROSS-REFERENCE TO RELATED APPLICATIONS

This application is a continuation of PCT Application No. PCT/JP2025/002234, filed on Jan. 24, 2025, which claims priority to Japanese Patent Application No. 2024-011103, filed on Jan. 29, 2024. The entire contents of each of the above-listed applications are incorporated herein by reference.

### TECHNICAL FIELD

The present disclosure relates to an antenna device, an antenna module, and a communication device.

### BACKGROUND ART

International Publication No. 2021/059661 (Patent Document 1) discloses an antenna device including radiating elements, a ground electrode, and peripheral electrodes. The radiating elements are formed in a dielectric substrate. The ground electrode is disposed opposite the radiating elements. The peripheral electrodes are formed in multiple layers between the radiating elements and the ground electrode, and are electrically connected to the ground electrode.

### CITATION LIST

### Patent Document

Patent Document 1: International Publication No. 2021/059661

### SUMMARY

The present disclosure is directed toward an antenna device, including a rectangular dielectric substrate that includes a plurality of laminated dielectric layers, the dielectric substrate having two pairs of opposite sides, at least one first radiating element in or on the rectangular dielectric substrate, at least one second radiating element adjacent to the at least one first radiating element in a first direction, the first direction being orthogonal to a lamination direction of the dielectric substrate and being parallel to one of the two pairs of opposite sides, a ground electrode opposite the at least one first radiating element and the at least one second radiating element, and at least one peripheral electrode including a plurality of layers between the at least one first radiating element and the ground electrode, the at least one peripheral electrode being electrically connected to the ground electrode and to the at least one second radiating element, wherein, in a plan view of the dielectric substrate in the lamination direction, a median line of the dielectric substrate extends along the first direction, the median line equally dividing the dielectric substrate, wherein the at least one second radiating element includes a first end portion and a second end portion opposite each other along a second direction, the second direction being orthogonal to the lamination direction and the first direction, and wherein, in the plan view of the dielectric substrate in the lamination direction, the first end portion of the at least one second radiating element is an open-circuited end, the first end portion being closer to the median line than the second end portion is in the second direction.

### BRIEF DESCRIPTION OF DRAWINGS

FIG. 1 is a block diagram illustrating a communication device to which an antenna module related to a first embodiment is applied.

FIG. 2 is a plan view of a portion of an antenna module related to the first embodiment.

FIG. 3 is a plan view of the entire antenna module in FIG. 2.

FIG. 4 is a perspective side view of the antenna module in FIG. 2.

FIG. 5 is a perspective view of a portion in the vicinity of peripheral electrodes in the antenna module in FIG. 2.

FIG. 6 is a diagram for describing the state of electric field lines between a first radiating element and a ground electrode in the case of absence of peripheral electrodes.

FIG. 7 is a diagram for describing the state of electric field lines between a first radiating element and a ground electrode in the case of presence of peripheral electrodes.

FIG. 8 is a diagram illustrating a simulation result of antenna characteristics in a first layout pattern.

FIG. 9 is a diagram illustrating a simulation result of antenna characteristics in a second layout pattern.

FIG. 10 is a diagram illustrating a simulation result of antenna characteristics in a third layout pattern.

FIG. 11 is a plan view of the entire antenna module related to a second embodiment.

FIG. 12 is a diagram illustrating a simulation result of antenna characteristics of an antenna module related to the second embodiment and a simulation result of antenna characteristics of a comparison example, in a millimeter-wave band having a center frequency of 39 GHz.

FIG. 13 is a plan view of the entire antenna module related to a third embodiment.

FIG. 14 is a diagram illustrating the configuration of feed lines of a second radiating element in the antenna module in FIG. 13.

FIG. 15 is a diagram illustrating a modified example of the antenna module in FIG. 2.

FIG. 16 is a graph comparing the simulation results in FIG. 12 in the form of cumulative distribution function.

### DESCRIPTION OF EMBODIMENTS

In the antenna device as disclosed in International Publication No. 2021/059661 (Patent Document 1), the peripheral electrodes are used to suppress degradation of the antenna characteristics which occurs when the size and/or the shape of the ground electrode is limited.

However, the antenna device described in Patent Document 1 has a problem in that the radiation direction of radio waves is limited to the normal direction of the dielectric substrate.

In contrast, the present disclosure is directed toward increasing the radiation coverage of radio waves in an antenna device while suppressing degradation of antenna characteristics caused by limitations in size and/or shape of a ground electrode.

Embodiments of the present disclosure will be described below in detail by referring to the drawings. Identical or corresponding components in the figures are designated with identical reference numerals, and repeated description will be avoided. The embodiments and modified examples of the present disclosure may be combined with each other.

### First Embodiment

### (Basic Configuration of Communication Device)

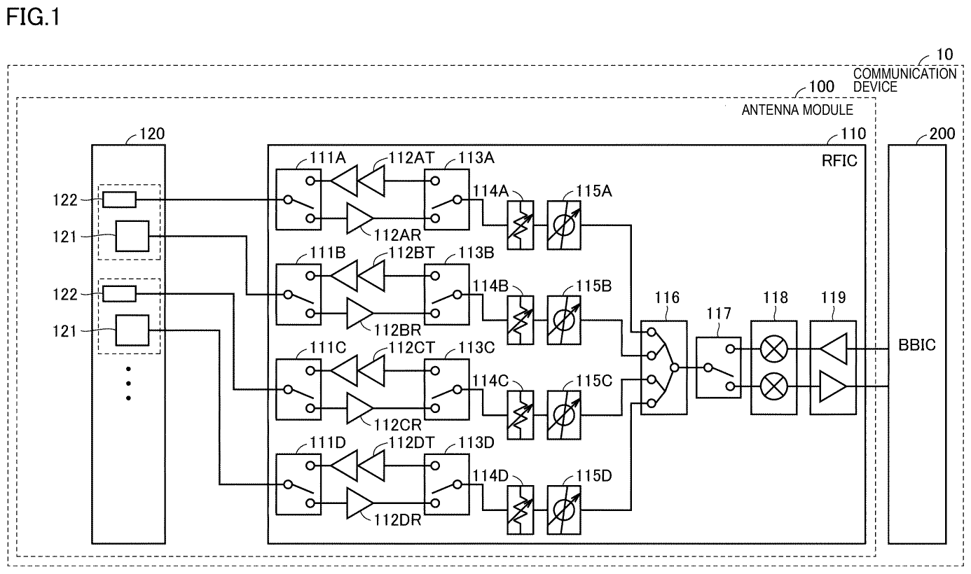

FIG. 1 is an example block diagram illustrating a communication device 10 to which an antenna module 100 according to a first embodiment is applied. Examples of the communication device 10 include a portable terminal, such as a cellular phone, a smartphone, or a tablet, and a personal computer provided with a communication function. An example of the frequency band of radio waves used in the antenna module 100 according to the present embodiment is radio waves in the millimeter-wave band having a center frequency, for example, of 28 GHz, 39 GHz, 60 GHz, or the like. However, radio waves of a frequency band other than the above band may be applied.

Referring to FIG. 1, the communication device 10 includes the antenna module 100 and a baseband integrated circuit (i.e., BBIC 200) forming a baseband signal processing circuit. The antenna module 100 includes a radio frequency integrated circuit (i.e., RFIC 110) which is an example of a feeding circuit, and an antenna device 120. The communication device 10 upconverts a signal, which has been transmitted from the BBIC 200 to the antenna module 100, to a radio frequency signal by using the RFIC 110, and radiates the radio frequency signal from the antenna device 120. The communication device 10 transmits a radio frequency signal, which has been received by the antenna device 120, to the RFIC 110, down-converts it, and uses the BBIC 200 to process the signal.

To facilitate the description, FIG. 1 illustrates only two first radiating elements 121 and two second radiating elements 122 among multiple first radiating elements (first fed elements) 121 and multiple second radiating elements (second fed elements) 122 included in the antenna device 120. However, the antenna device 120 may include three or more first radiating elements 121 and three or more second radiating elements 122. Alternatively, the antenna device 120 may include one first radiating element 121 and one second radiating element 122.

In the present embodiment, the first radiating elements 121 form planar patch antennas; the second radiating elements form planar inverted-F antennas (PIFAs).

The RFIC 110 includes switches 111A to 111D, 113A to 113D, and 117, power amplifiers 112AT to 112DT, low-noise amplifiers 112AR to 112DR, attenuators 114A to 114D, phase shifters 115A to 115D, a signal combiner/splitter 116, a mixer 118, and an amplifier circuit 119.

In transmission of a radio frequency signal, the switches 111A to 111D and 113A to 113D are switched to the power amplifiers 112AT to 112DT, and the switch 117 is connected to the transmission amplifier of the amplifier circuit 119. In reception of a radio frequency signal, the switches 111A to 111D and 113A to 113D are switched to the low-noise amplifiers 112AR to 112DR, and the switch 117 is connected to the reception amplifier of the amplifier circuit 119.

A signal transmitted from the BBIC 200 is amplified by the amplifier circuit 119, and is upconverted by the mixer 118. The transmit signal, which is an upconverted radio frequency signal, is split to four signals by the signal combiner/splitter 116. The four signals pass through four signal paths, and are fed to the respective different first and second radiating elements 121 and 122. At that time, the phase shift amounts of the phase shifters 115A to 115D disposed on the signal paths are adjusted individually, enabling the directivity of the antenna device 120 to be adjusted.

Receive signals, which are radio frequency signals having received at the respective first and second radiating elements 121 and 122, pass through the respective four different signal paths, and are combined by the signal combiner/splitter 116. The combined receive signal is down-converted by the mixer 118, and is amplified by the amplifier circuit 119 and transmitted to the BBIC 200.

The RFIC 110 is formed, for example, as a single-chip integrated circuit component including the above circuit configuration. Alternatively, devices in the RFIC 110 (a switch, a power amplifier, a low-noise amplifier, an attenuator, and a phase shifter) which correspond to each of the first radiating elements 121 may be formed as a single-chip integrated circuit component for the first radiating element 121. Similarly, devices in the RFIC 110 (a switch, a power amplifier, a low-noise amplifier, an attenuator, and a phase shifter) which correspond to each of the second radiating elements 122 may be formed as a single-chip integrated circuit component for the second radiating element 122.

### (Configuration of Antenna Module)

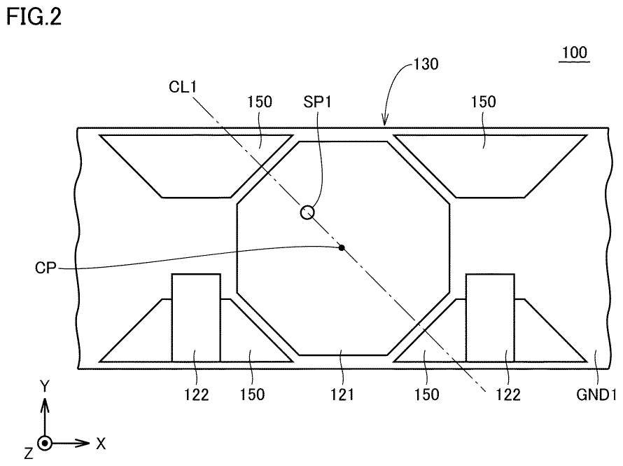

FIGS. 2 to 5 are used to describe the details of the configuration of the antenna module 100 in the first embodiment.

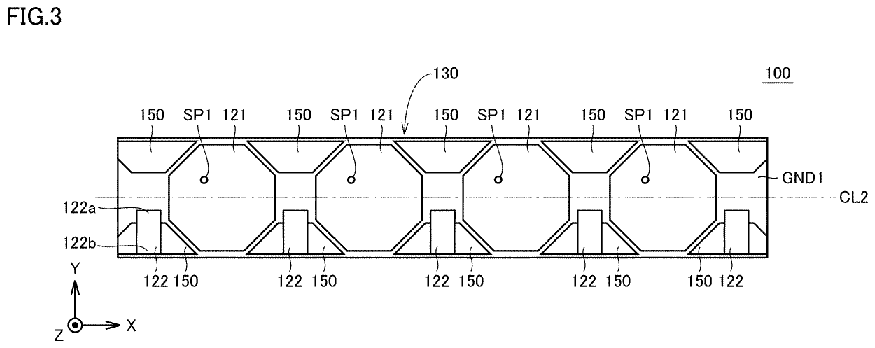

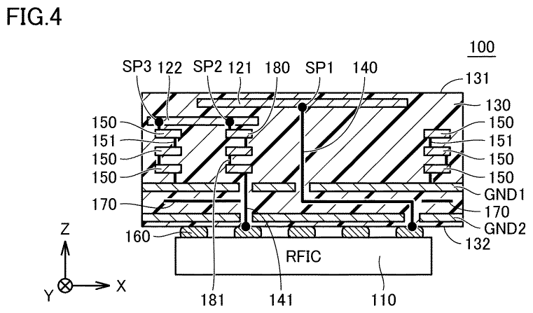

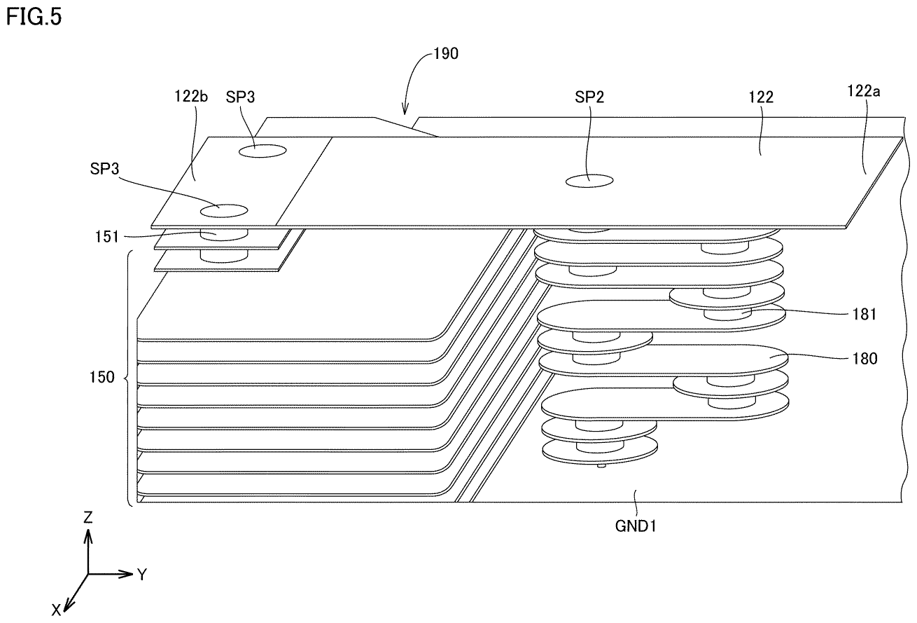

FIG. 2 is a plan view of a portion of the antenna module 100 related to the first embodiment. FIG. 3 is a plan view of the entire antenna module 100 in FIG. 2. FIG. 4 is a perspective side view of the antenna module 100 in FIG. 2. FIG. 5 is a perspective view of a portion in the vicinity of peripheral electrodes 150 in the antenna module 100 in FIG. 2. In the plan views in FIGS. 2 and 3, dielectric layers are not illustrated to view internal electrodes.

Referring to FIGS. 2 to 5, the antenna module 100 includes a dielectric substrate 130, feed wiring lines 140 and 141, peripheral electrodes 150, power-feeding electrodes 180, and ground electrodes GND1 and GND2 in addition to the first radiating elements 121, the second radiating elements 122, and the RFIC 110. In the description below, the normal direction of the dielectric substrate 130 is assumed to be the Z-axis direction, and the surface perpendicular to the Z-axis direction is defined by using the X axis and the Y axis. The positive Z-axis direction in the figures may be referred to as the upper side; the negative Z-axis direction may be referred to as the lower side.

The dielectric substrate 130 is, for example, a multilayer low temperature co-fired ceramics (LTCC) substrate, a multilayer resin substrate formed by laminating multiple resin layers formed of resin, such as epoxy or polyimide, a multilayer resin substrate formed by laminating multiple resin layers formed of liquid crystal polymer (LCP) having a lower dielectric constant, a multilayer resin substrate formed by laminating multiple resin layers formed of fluororesin, or a multilayer ceramic substrate other than LTCC. The dielectric substrate 130 is an example of a rectangular dielectric substrate having multiple laminated dielectric layers and having two pairs of opposite sides.

The dielectric substrate 130 is approximately rectangular. In the description below, the surface in the positive Z-axis direction of the dielectric substrate 130 is referred to as the upper surface; the surface in the negative Z-axis direction of the dielectric substrate 130 is referred to as the lower surface; a surface orthogonal to the upper surface and the lower surface is referred to as a side surface.

As illustrated in FIG. 2, each first radiating element 121 is shaped like an octagon (e.g., in a plan view). A feeding point SP1 of each first radiating element 121 is disposed at a position offset from a surface center CP of the first radiating element 121 by equal distances in the negative X-axis direction and the positive Y-axis direction. Therefore, the polarization direction in the antenna module 100 is the direction along the long dashed short dashed line CL1 in FIG. 2.

As illustrated in FIG. 3, in a plan view of the dielectric substrate 130 in the normal direction (the Z-axis direction), the multiple peripheral electrodes 150 are disposed in both end portions in the Y-axis direction of the dielectric substrate 130. For example, as illustrated in FIG. 3, the dielectric substrate 130 includes opposite long edges that extend lengthwise in the X-axis direction and are spaced apart from each other in the Y-axis direction, and the multiple peripheral electrodes 150 are spaced apart from each other in the X-axis direction along each of the two opposite long edges of the dielectric substrate 130. In a plan view of the dielectric substrate 130 in the normal direction (the Z-axis direction), the peripheral electrodes 150 are trapezoidal. Each of the peripheral electrodes 150 is disposed along a side in the polarization direction of a corresponding first radiating element 121 and along a side orthogonal to the polarization direction of a corresponding first radiating element 121. In other words, an oblique side of each peripheral electrode 150 is disposed along a side of a corresponding first radiating element 121 that is along its polarization direction or orthogonal to the polarization direction. For example, referring to FIG. 2, each of the peripheral electrodes 150 has a first non-parallel side along a side of the first radiating element 121 that is parallel or orthogonal to its polarization direction, and a second non-parallel side orthogonal to the first side. The peripheral electrodes 150 are disposed so as to surround the first radiating elements 121 on the four sides (e.g., four peripheral electrodes 150 may be disposed along four sides of each of the octagonal first radiating elements 121).

The second radiating elements 122 are disposed above the peripheral electrodes 150 disposed in one of both end portions in the Y-axis direction of the dielectric substrate 130 (e.g., each of the second radiating elements 122 may be between a corresponding first radiating element 121 and corresponding peripheral electrodes 150 in the Z-axis direction). For example, referring to FIG. 3, the second radiating elements 122 may be aligned along one of the opposite long edges of the dielectric substrate 130. The second radiating elements 122 are, for example, planar. As illustrated in FIG. 3, the first radiating elements 121 and the second radiating elements 122 are disposed in the dielectric substrate 130 alternately in the X-axis direction.

The antenna module 100 includes two first radiating elements 121 disposed side by side in the first direction (the X-axis direction). A second radiating element 122 is disposed between the two first radiating elements 121. The second radiating elements 122 are examples of a second radiating element disposed adjacent to first radiating elements 121 in the first direction (the X-axis direction) which is orthogonal to the lamination direction of the dielectric substrate 130 and which is parallel to one of the two pairs of opposite sides.

As illustrated in FIG. 4, the first radiating elements 121 are formed in a layer (upper-side layer) close to an upper surface 131 of the dielectric substrate 130. The first radiating elements 121 may be exposed on the upper surface 131 of the dielectric substrate 130, or may be disposed in an inside layer of the dielectric substrate 130. In the first embodiment, to facilitate the description, an example in which the first radiating elements 121 are used as fed elements will be described. However, the first radiating elements 121 may be unfed elements and/or parasitic elements.

The second radiating elements 122 are formed in a layer below the layer in which the first radiating elements 121 are formed. The second radiating elements 122 may be disposed in the same layer in which the first radiating elements 121 are disposed.

In a layer (lower-side layer) of the dielectric substrate 130 closer to a lower surface 132 than the first radiating elements 121 and the second radiating elements 122, the planar ground electrode GND2 is disposed opposite the first radiating elements 121 and the second radiating elements 122. The ground electrode GND1 is disposed in a layer between the ground electrode GND2 and the first and second radiating elements 121 and 122.

A layer between the ground electrode GND1 and the ground electrode GND2 is used as a wiring region. Wiring patterns 170 are disposed in the wiring region. The wiring patterns 170 include feed wiring lines for supplying radio frequency signals to the first radiating elements 121 and the second radiating elements 122, stubs and filters connected to the feed wiring lines, and connection lines for connection with other electronic components. Thus, by using the ground electrode GND1 as a boundary, the wiring region is formed in the dielectric layer on the side opposite the first radiating elements 121 and the second radiating elements 122. This achieves suppression of unnecessary coupling between the first and second radiating elements 121 and 122 and the wiring patterns 170.

On the lower surface 132 of the dielectric substrate 130, the RFIC 110 is mounted through solder bumps 160. Instead of solder connection, the RFIC 110 may be connected to the dielectric substrate 130 by using a multipole connector.

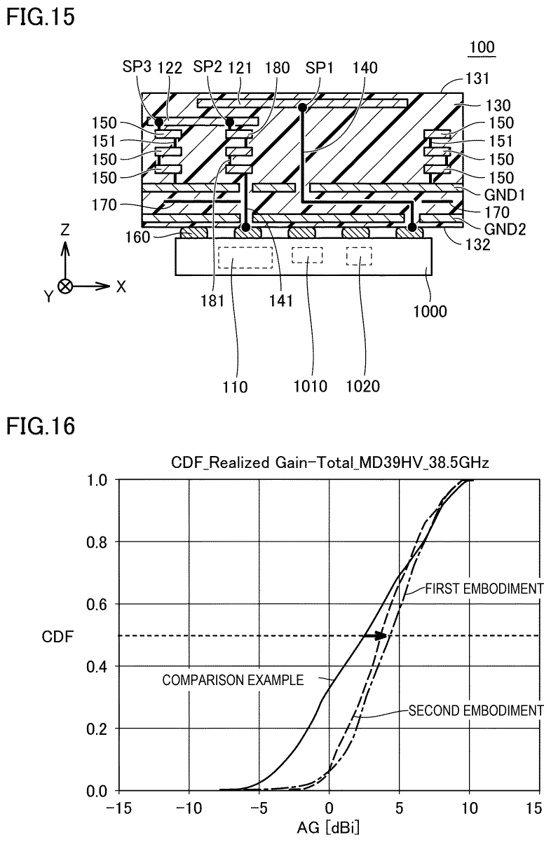

FIG. 15 is a diagram illustrating a modified example of the antenna module 100 in FIG. 2. As illustrated in FIG. 15, on the lower surface 132 of the dielectric substrate 130, a SiP (System In Package) module 1000 including the RFIC 110 may be disposed. The SiP module 1000 may include a power module IC 1010 and a power inductor 1020 in addition to the RFIC 110.

Referring back to FIG. 4, the peripheral electrodes 150 are formed between the first radiating elements 121 and the ground electrode GND1 (e.g., the peripheral electrodes 150 may include a plurality of layers spaced apart from each other between the second radiating element 122 and the ground electrode GND1). The peripheral electrodes 150 are electrically connected to the ground electrode GND1 and the second radiating elements 122. In plan view of the dielectric substrate 130, the peripheral electrodes 150 are disposed so as to overlap each other in the lamination direction (e.g., in the Z-axis direction). That is, the peripheral electrodes 150 form virtual conducting walls along the sides of the dielectric substrate 130. The peripheral electrodes 150 adjacent to each other in the lamination direction are electrically connected through vias 151. Further, the lowest peripheral electrodes 150 are electrically connected to the ground electrode GND1 through vias 151. That is, the peripheral electrodes 150 have substantially an equivalent configuration in which the end portions of the ground electrode GND1 extend in the lamination direction. Thus, the peripheral electrodes 150 are electrically connected to the second radiating elements 122 and the ground electrode GND1. The peripheral electrodes 150 stacked in the lamination direction do not necessarily have the same shape. For example, in the lamination direction of the dielectric substrate 130, peripheral electrodes 150 that are closer to the ground electrode GND1 may be larger in size.

In the antenna module 100, the vias 151 formed in the dielectric layers adjacent to each other in the lamination direction may be disposed so as not to overlap each other in plan view in the normal direction of the dielectric substrate 130. A conductive material (e.g., copper) of which the vias 151 are formed has a small compressibility in pressure compared with a dielectric material. Therefore, if all the vias 151 in the layers were to be disposed at the same position in plan view in the normal direction of the dielectric substrate 130, when the dielectric substrate 130 is pressed to laminate the dielectric layers, the decrease rate of the thickness of the via 151 portions may decrease compared with the other dielectric portions, resulting in non-uniformity in the thickness of the entire dielectric substrate 130. Therefore, as described above, the vias 151 in dielectric layers adjacent to each other in the lamination direction are disposed at different positions, improving the accuracy in the thickness of the molded dielectric substrate 130.

Electrical connection between the peripheral electrodes 150 and that between the peripheral electrodes 150 and the ground electrode GND1 are not limited to direct connection through the vias 151. Some or all of the electrodes may be capacitively coupled to each other. In addition, the peripheral electrodes 150 may be formed integrally, not by coupling individual components.

As illustrated in FIG. 3, among the peripheral electrodes 150 disposed on both ends of the dielectric substrate 130 (i.e., along opposite long edges of the dielectric substrate 130), the second radiating elements 122 are disposed above those on one side (e.g., only along one of the opposite long edges of the dielectric substrate 130). As illustrated in FIGS. 4 and 5, each of the second radiating elements 122 has a feeding point SP2 and short-circuit points SP3. Each of the second radiating elements 122 is connected to the corresponding peripheral electrodes 150 at the short-circuit points SP3. The short-circuit points SP3 are connected to the corresponding peripheral electrodes 150 through the corresponding vias 151.

A radio frequency signal is supplied from the RFIC 110 to the feeding point SP1 of the first radiating element 121 through the feed wiring line 140. The feed wiring line 140 rises from the RFIC 110 through the ground electrode GND2, and extends in the wiring region. The feed wiring line 140 rises through the ground electrode GND1 from just below the first radiating element 121, and is connected to the feeding point SP1 of the first radiating element 121.

A radio frequency signal is supplied from the RFIC 110 to the feeding point SP2 of the second radiating element 122 through the feed wiring line 141 and the power-feeding electrodes 180. The feed wiring line 141 rises through the ground electrode GND2 from the RFIC 110, and extends in the wiring region. The feed wiring line 141 rises through the ground electrode GND1, and is connected to the power-feeding electrode 180. Multiple power-feeding electrodes 180 are disposed between the second radiating element 122 and the ground electrode GND1. The power-feeding electrodes 180 are connected to each other through vias 181. The feeding point SP2 may be connected to the wiring region through a feed wiring line as in the configuration between the feeding point SP1 and the wiring region.

As illustrated in FIGS. 3 and 5, in plan view of the dielectric substrate 130 in the lamination direction, among both end portions of the second radiating element 122 in a second direction (the Y-axis direction) orthogonal to the lamination direction and the first direction (the X-axis direction), a first end portion 122a close to a median line CL2 equally dividing the dielectric substrate into two in the first direction is an open-circuited end. That is, the median line CL2 extends in the first direction (the X-axis direction) to be equidistant from the opposite long edges of the dielectric substrate 130 in the second direction.

Each of the second radiating elements 122 is connected to the corresponding peripheral electrodes 150 in a second end portion 122b opposite the first end portion 122a. For example, the second radiating element 122 has a linear shape extending in the second direction, with the first and second end portions 122a and 122b at opposite sides thereof, such that the second radiating element 122 overlaps a top of the peripheral electrode 150, and the first end portion 122a overhangs the peripheral electrode 150 in the second direction.

The short-circuit points SP3 are disposed in the second end portion 122b. The short-circuit points SP3 are grounded to the ground electrode GND1 through the corresponding peripheral electrodes 150.

Thus, each of the second radiating elements 122 is a “one-sided grounded patch”. Each of the second radiating elements 122 is supplied with power at its feeding point SP2. Therefore, each of the second radiating elements 122 forms a planar inverted-F antenna 190 in which the corresponding peripheral electrodes 150 are used as a short-circuit element and in which a feed wiring line 141 and the corresponding power-feeding electrodes 180 are used as a fed element. Adjustment of the size in the Y-axis direction of the second radiating elements 122 causes the frequency band of the planar inverted-F antennas 190 to be set to an appropriate range.

As illustrated in FIG. 3, in plan view in the normal direction of the dielectric substrate 130, the second radiating elements 122 forming the planar inverted-F antennas 190 are disposed at positions where the second radiating elements 122 do not overlap (e.g., have a non-overlapping relationship with) the first radiating elements 121 in the Z-axis direction. A straight line connecting the first end portion 122a (see FIG. 5) to the second end portion 122b (see FIG. 5) of a second radiating element 122 crosses the direction (the X-axis direction) in which the first radiating elements 121 are arranged. Each peripheral electrode 150 is formed so that the peripheral electrode 150 extends longer in the direction in which the first radiating elements 121 are arranged (e.g., a length of each peripheral electrode 150 in the first direction may be longer than its width in the second direction).

### (Effects of Peripheral Electrodes)

Typically, in a patch antenna having a planar radiating element as the first radiating element 121, radio waves are radiated by using electromagnetic field coupling between the radiating element and a ground electrode. To attain desired antenna characteristics in such a patch antenna, it is necessary to dispose the ground electrode having an area wide enough for the radiating element.

In contrast, in a portable terminal, such as a cellular phone or a smartphone, in which a patch antenna is employed, demands for reduction in size and thickness remain high. Accordingly, a further reduction in size of an embedded antenna device is required.

However, when an antenna device is disposed in a limited space in a case, it may be difficult to make a ground electrode wide enough for a radiating element. In some cases, an installation location of an antenna device or positional relationship with peripheral devices may hinder the ground electrode from having a symmetric shape. Thus, limitations of the size and the shape of the ground electrode may cause disturbance of electric field lines between the radiating element and the ground electrode, resulting in influence on antenna characteristics, such as gain, frequency band, or directivity.

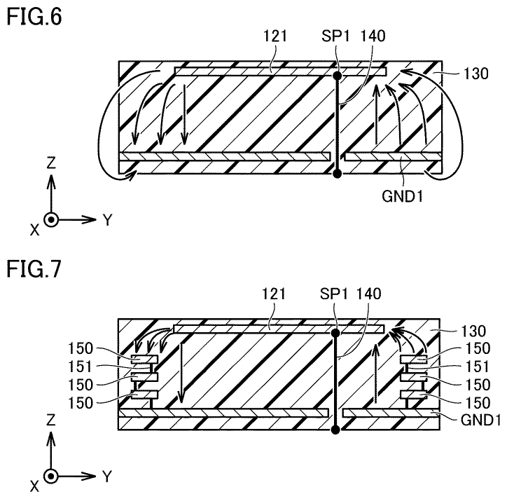

Accordingly, in the first embodiment, in order to suppress degradation of antenna characteristics in the case where the size and/or the shape of a ground electrode is limited, an antenna module with the peripheral electrodes 150 is proposed. This will be described below in more detail, with reference to FIGS. 6 and 7.

FIG. 6 is a diagram for describing the state of electric field lines between the first radiating element 121 and the ground electrode GND1 in the case of absence of peripheral electrodes 150. FIG. 7 is a diagram for describing the state of electric field lines between the first radiating element 121 and the ground electrode GND1 in the case of having the peripheral electrodes 150 therebetween. FIGS. 6 and 7 are cross-sectional views obtained when the dielectric substrate 130 is cut in the YZ plane in a portion not including the second radiating elements 122.

When a radio frequency signal is supplied to the first radiating element 121, electromagnetic field coupling occurs between the end portions of the first radiating element 121 and the ground electrode GND1. At that time, electric field lines are emitted from one end portion of the first radiating element 121 to the ground electrode GND1; electric field lines from the ground electrode GND1 are received at the other end portion.

When the area of the ground electrode GND1 is wide enough for the first radiating element 121, electric field lines are received on the ground electrode GND1's surface opposite (e.g., facing) the first radiating element 121. However, when the ground electrode GND1 does not have an area wide enough, as illustrated in FIG. 6, some of the electric field lines may extend around an edge of the ground electrode GND1 to the back surface of the ground electrode GND1. This increases the ratio of radio waves radiated to the back surface of the antenna device, which may cause disturbance of directivity resulting in degradation of the antenna gain in a desired direction, a narrower frequency bandwidth, or change of the polarization direction as in circular polarization.

In the antenna module 100 related to the first embodiment, as illustrated in FIG. 7, peripheral electrodes 150 electrically connected to the ground electrode GND1 are disposed in layers between the first radiating element 121 and the ground electrode GND1. The distance between a peripheral electrode 150 and the first radiating element 121 is shorter than that between the ground electrode GND1 and the first radiating element 121. Thus, the peripheral electrode 150 has a stronger electromagnetic field coupling to the first radiating element 121 than the ground electrode GND1 has. Therefore, the electric field lines extending around to the back surface of the ground electrode GND1 in FIG. 6 are formed between the peripheral electrode 150 and the first radiating element 121 in FIG. 7. This achieves suppression of radiation of radio waves to the back surface of the antenna device, resulting in suppression of degradation of the antenna characteristics such as gain.

The peripheral electrodes 150 are disposed at symmetric positions in the polarization direction of radio waves and/or the direction orthogonal to the polarization direction. This may improve symmetry of the electric field lines formed between the first radiating element 121 and the ground electrode GND1. The peripheral electrodes 150, which are disposed at symmetric positions in the polarization direction of radio waves and/or the direction orthogonal to the polarization direction, may enhance the coupling degree between the first radiating element 121 and the ground electrode GND1, and may improve symmetry of the electric field lines formed between the first radiating element 121 and the ground electrode GND1. As a result, the degradation of antenna characteristics may be suppressed.

### (Effects of Inverted-F Antenna Including Peripheral Electrodes)

Thus, according to the first embodiment, the peripheral electrodes 150 are disposed in the antenna module 100 in addition to the first radiating elements 121. Thus, the degradation of antenna characteristics may be suppressed when the size and/or the shape of the ground electrode is limited. However, when only the first radiating elements 121 are disposed as radiating elements in the antenna module 100, the radiation direction of radio waves in the antenna module 100 is limited to the normal direction (positive Z-axis direction) of the dielectric substrate 130.

Typically, an idea for increasing the radiation coverage of radio waves in an antenna module including a patch antenna is to dispose a dipole antenna around the patch antenna included in the dielectric substrate. Thus, in addition to the normal direction of the dielectric substrate, the antenna module is capable of radiating radio waves also in the side direction (the direction orthogonal to the normal direction of the dielectric substrate) of the dielectric substrate. Therefore, to increase the radiation coverage of radio waves, an improvement proposal of disposing a dipole antenna in addition to the first radiating elements 121 in the antenna module 100 may be employed.

However, such an improvement proposal needs an area in which the dipole antenna is disposed, resulting in necessity of increasing the size of the dielectric substrate 130. This fails in meeting the needs of reduction in size of an antenna device and an antenna module.

Accordingly, in the first embodiment, arrangement of the planar inverted-F antennas 190 in the dielectric substrate 130 through the utilization of the peripheral electrodes 150 and a vacant area, which is formed due to arrangement of the peripheral electrodes 150, is proposed.

As illustrated in FIGS. 4 and 5, in the first embodiment, the peripheral electrodes 150 function as short-circuit elements of the planar inverted-F antennas 190. Therefore, the peripheral electrodes 150 for suppressing the degradation of antenna characteristics are utilized as short-circuit elements of the planar inverted-F antennas 190 in the first embodiment.

Further, the second radiating elements 122 included in the planar inverted-F antennas 190 are disposed in the vacant area in the dielectric substrate 130 which is formed due to arrangement of the peripheral electrodes 150 adjacent to the first radiating elements 121. In other words, in the first embodiment, the vacant area which is formed due to arrangement of the peripheral electrodes 150 adjacent to the first radiating elements 121 is utilized as a region for disposing the second radiating elements 122.

As described above, in the first embodiment, by utilizing the peripheral electrodes 150 and the vacant area which is formed due to arrangement of the peripheral electrodes 150, the planar inverted-F antennas 190 are disposed in the dielectric substrate 130. The peripheral electrodes 150 function as short-circuit elements. Thus, the planar inverted-F antennas 190 radiate radio waves in a direction different from the normal direction of the dielectric substrate 130. More specifically, the second radiating elements 122 included in the planar inverted-F antennas 190 radiate radio waves in the side direction of the dielectric substrate 130, especially, the Y-axis direction or a direction around the Y axis.

Thus, the antenna module 100 related to the first embodiment achieves increase in the radiation coverage of radio waves with suppression of degradation of antenna characteristics caused by limitations in size and/or shape of a ground electrode.

### (Radio-Wave Radiation Direction of Second Radiating Elements)

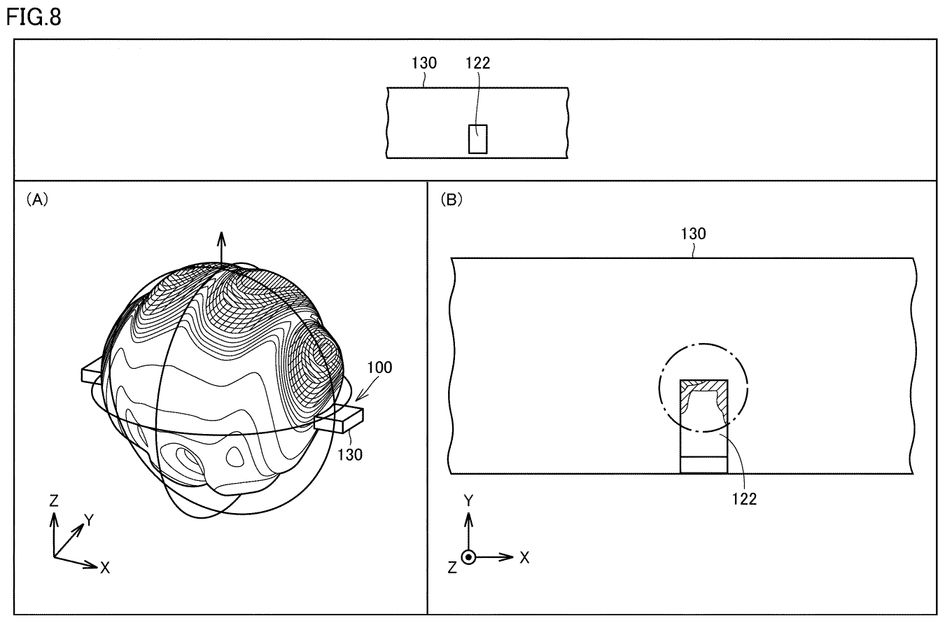

Referring to FIGS. 8 to 10, the radio-wave radiation direction of the second radiating element 122 included in the planar inverted-F antenna 190 will be described in more detail below.

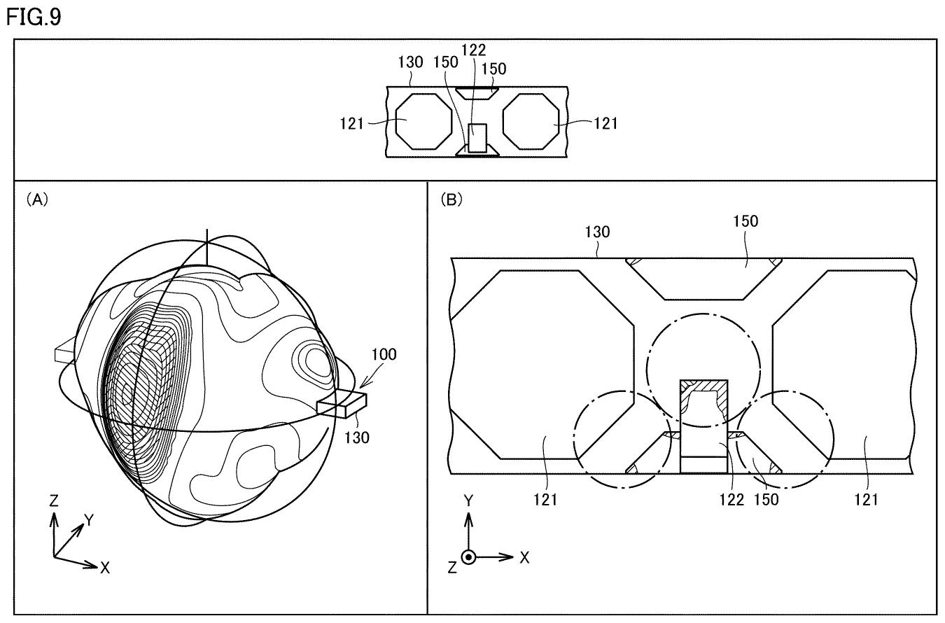

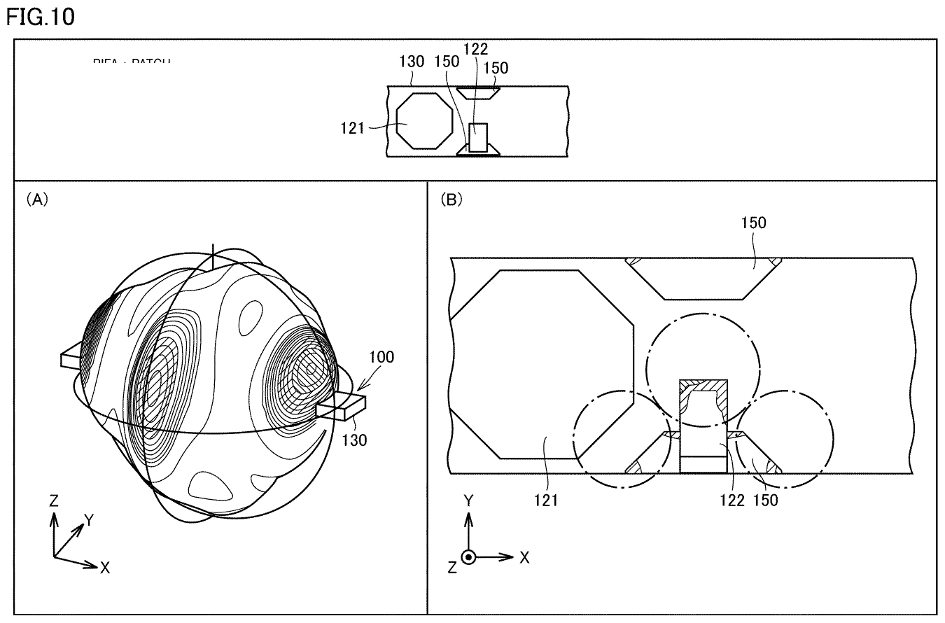

FIG. 8 is a diagram illustrating a simulation result of antenna characteristics in a first layout pattern. FIG. 9 is a diagram illustrating a simulation result of antenna characteristics in a second layout pattern. FIG. 10 is a diagram illustrating a simulation result of antenna characteristics in a third layout pattern.

In any of the first to third layout patterns, the short-circuit points SP3 of a second radiating element 122 are grounded to the ground electrode GND1, and the feeding point SP2 of the second radiating element 122 is supplied with power. That is, in any of the first to third layout patterns, the second radiating element 122 functions as a planar inverted-F antenna.

In (A) in FIGS. 8 to 10, the gain distribution is illustrated; in (B) in FIGS. 8 to 10, the electric field distribution is illustrated. The difference in hatching in the gain distribution indicates the difference in height of the gain. Similarly, the difference in hatching in the electric field distribution indicates the difference in strength of the electric field.

First, referring to FIG. 8, the gain distribution and the electric field distribution in the first layout pattern will be described. In the first layout pattern, in the dielectric substrate 130 in which the first radiating elements 121 and the peripheral electrodes 150 are not disposed, a second radiating element 122 is disposed. As illustrated in FIG. 8(A), in the first layout pattern, the second radiating element 122 radiates strong radio waves at least in the positive Z-axis direction. However, in the first layout pattern, the second radiating element 122 does not radiate strong radio waves, as seen in the positive Z-axis direction, in the Y-axis direction. As illustrated in FIG. 8(B), in the first layout pattern, among both ends in the Y-axis direction of the second radiating element 122, a strong electric field occurs on the far side from the end portion of the dielectric substrate 130, that is, in the vicinity of the open-circuited end of the second radiating element 122 included in the planar inverted-F antenna (see the round frame portion in FIG. 8(B)).

Referring to FIG. 9, the gain distribution and the electric field distribution in the second layout pattern will be described. In the second layout pattern, a second radiating element 122 is disposed in the dielectric substrate 130 in which two first radiating elements 121 are disposed side by side in the X-axis direction with peripheral electrodes 150 interposed in between. The second radiating element 122 is disposed above a peripheral electrode 150. That is, the second layout pattern is included in the antenna module 100 illustrated in FIG. 3. However, the gain distribution and the electric field distribution illustrated in FIG. 9 are a simulation result obtained when the first radiating elements 121 are set so as not to be supplied with power.

As illustrated in FIG. 9(A), in the second layout pattern, the second radiating element 122 radiates strong radio waves at least in the negative Y-axis direction. The negative Y-axis direction corresponds to the direction (the side direction of the dielectric substrate 130) orthogonal to the normal direction of the dielectric substrate 130. As illustrated in FIG. 9(B), in the second layout pattern, a strong electric field is formed in the vicinity of the open-circuited end of the planar inverted-F antenna including the second radiating element 122, and in the peripheral electrode 150 (see the round frame portions in FIG. 9(B)). In particular, a strong electric field is formed in the peripheral electrode 150's portions near the first radiating elements 121.

As seen from the simulation results illustrated in FIGS. 8 and 9, the second radiating element 122 radiates strong radio waves in the side direction of the dielectric substrate 130 in the second layout pattern. Therefore, according to the antenna module 100 having a configuration similar to the second layout pattern, the second radiating elements 122 radiate strong radio waves in the side direction of the dielectric substrate 130. In addition, in the antenna module 100, the first radiating elements 121, which are supplied with power, radiate strong radio waves in the normal direction of the dielectric substrate 130. Therefore, the antenna module 100 achieves increase in the radiation coverage of radio waves.

Referring to FIG. 10, the gain distribution and the electric field distribution in the third layout pattern will be described. In the third layout pattern, one of the two first radiating elements 121 is removed from the second layout pattern illustrated in FIG. 9. The gain distribution and the electric field distribution illustrated in FIG. 10 are a simulation result obtained when the first radiating element 121 is set so as not to be supplied with power.

As illustrated in FIG. 10(A), in the third layout pattern, the second radiating element 122 radiates strong radio waves at least in the negative Y-axis direction. In the third layout pattern, the second radiating element 122 radiates strong radio waves also in the X-axis direction. As illustrated in FIG. 10(A), in the third layout pattern, a strong electric field is formed near the open-circuited end of the planar inverted-F antenna including the second radiating element 122 and in a peripheral electrode 150 (see round frame portions in FIG. 10(B)). Especially, a strong electric field is formed in the vicinity of the end portions (including a portion close to the first radiating element 121) of the peripheral electrode 150.

As seen from the simulation result illustrated in FIG. 10, also in the third layout pattern, the second radiating element 122 radiates strong radio waves in the side direction of the dielectric substrate 130. Therefore, as the configuration of the antenna module 100, the configuration illustrated in the third layout pattern may be employed instead of the configuration illustrated in the second layout pattern. That is, the antenna module 100 may have any configuration as long as it includes at least one first radiating element 121, one second radiating element 122, and one peripheral electrode 150.

In the second layout pattern and the third layout pattern, the reason why the second radiating element 122 radiates radio waves in the side direction of the dielectric substrate 130 will be discussed. As in the first layout pattern, when only a second radiating element 122 is disposed in the dielectric substrate 130, an electric field concentrates in the vicinity of the open-circuited end of the second radiating element 122 included in a planar inverted-F antenna. At that time, radio waves are radiated in the normal direction of the dielectric substrate 130.

In the second layout pattern and the third layout pattern, a peripheral electrode 150 is used as a short-circuit portion of the planar inverted-F antenna. In the second layout pattern and the third layout pattern, electric fields concentrate not only at the open-circuited end of the second radiating element 122, but also in the peripheral electrode 150. Especially, in the peripheral electrode 150, electric fields concentrate also in portions close to the first radiating element 121. Thus, the state of the electric field distribution changes between the first layout pattern and the second or third layout pattern.

When the layout pattern is switched from the first layout pattern to the second layout pattern, the radiation direction of radio waves is inclined from the normal direction of the dielectric substrate 130 to the short-circuit portion direction of the planar inverted-F antenna, that is, the side direction of the dielectric substrate 130. The same is true for switching from the first layout pattern to the third layout pattern.

Therefore, the change in the electric field distribution may cause the radio-wave radiation direction of the second radiating element 122 to be changed from the normal direction to the side direction of the dielectric substrate 130.

As described above, according to the first embodiment, the second radiating elements 122 are disposed as in the second layout pattern or the third layout pattern in the dielectric substrate 130 in which the first radiating elements 121 and the peripheral electrodes 150 are disposed, achieving increase in the radiation coverage (communication range) of the antenna module 100. In the first embodiment, the peripheral electrodes 150 and the vacant area which is formed due to arrangement of the peripheral electrodes 150 are utilized. Therefore, in the first embodiment, more radiating surfaces may be provided without unnecessary increase in the area.

### Second Embodiment

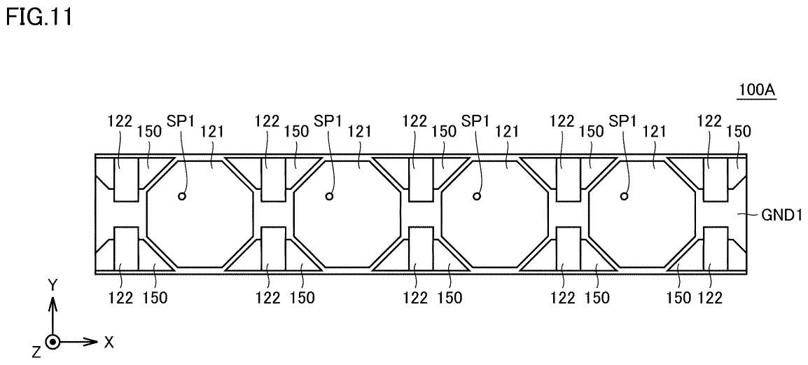

FIG. 11 is a plan view of the entire antenna module 100A related to a second embodiment. In the antenna module 100A related to the second embodiment, the second radiating elements 122 are disposed in both end portions in the Y-axis direction of the dielectric substrate 130. In this point, the antenna module 100A related to the second embodiment is different from the antenna module 100 related to the first embodiment.

According to the antenna module 100 related to the first embodiment which has been described, radio waves are radiated in the normal direction and the side direction of the dielectric substrate 130. More specifically, the antenna module 100 may radiate radio waves in the normal direction and the negative Y-axis direction of the dielectric substrate 130. However, the antenna module 100 is not capable of radiating radio waves in the positive Y-axis direction.

In the antenna module 100A related to the second embodiment, in plan view of the dielectric substrate 130 in the lamination direction, two peripheral electrodes 150 are disposed so as to be opposite each other in the second direction (the Y-axis direction), and the second radiating elements 122 are disposed on the respective two peripheral electrodes 150. The antenna module 100A related to the second embodiment is capable of radiating radio waves in the positive Y-axis direction and the negative Y-axis direction.

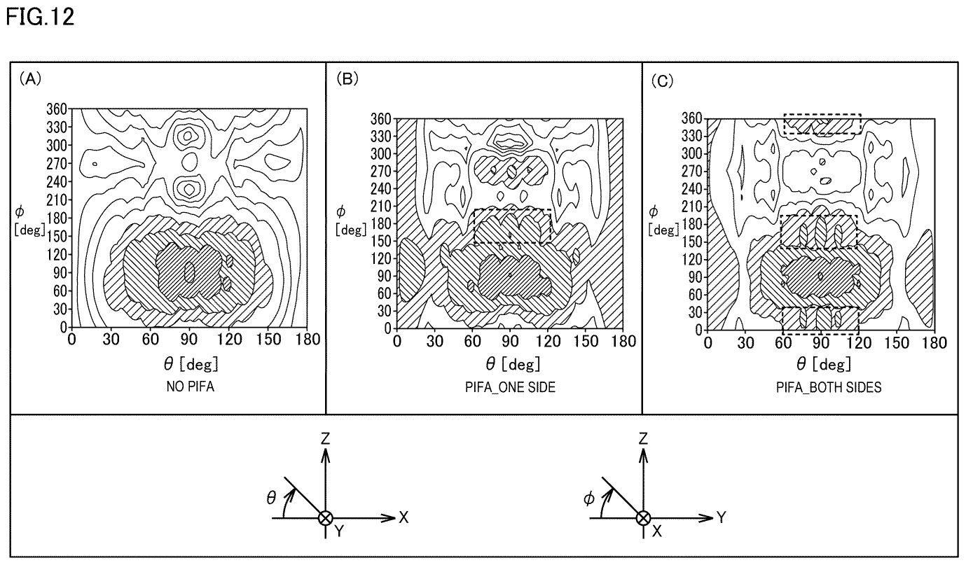

FIG. 12 is a diagram illustrating a simulation result of the antenna characteristics of the antenna module 100A related to the second embodiment and a simulation result of the antenna characteristics of a comparison example, in a millimeter-wave band having a center frequency of 39 GHz.

FIG. 12(A) illustrates a contour diagram corresponding to the case in which the planar inverted-F antennas 190 are not disposed in the dielectric substrate 130. The contour diagram illustrated in FIG. 12(A) illustrates the gain distribution in the case where the second radiating elements 122 functioning as the planar inverted-F antennas 190 are removed from the antenna module 100 related to the first embodiment.

FIG. 12(B) illustrates a contour diagram corresponding to the case where the planar inverted-F antennas 190 are disposed at one end of the dielectric substrate 130. The contour diagram illustrated in FIG. 12(B) illustrates the gain distribution of the antenna module 100 related to the first embodiment.

FIG. 12(C) illustrates a contour diagram corresponding to the case where the planar inverted-F antennas 190 are disposed at both ends of the dielectric substrate 130. The contour diagram illustrated in FIG. 12(C) illustrates the gain distribution of the antenna module 100A related to the second embodiment.

In FIG. 12(A) to 12(C), the horizontal axis represents the angle θ about the Y axis with respect to the X-axis direction; the vertical axis represents the angle φ about the X axis with respect to the Y-axis direction. The difference in hatching indicates the difference in height of the gain.

Referring to FIG. 12(A), the case in which the planar inverted-F antennas 190 are not disposed in the dielectric substrate 130 will be described. In this case, radio waves are radiated in the normal direction (the Z-axis direction) of the dielectric substrate 130, while radio waves are not radiated in the side direction (the Y-axis direction) of the dielectric substrate 130. The first radiating elements 121 radiate radio waves in the normal direction of the dielectric substrate 130.

Referring to FIG. 12(B), the case where the planar inverted-F antennas 190 are disposed at one end of the dielectric substrate 130, that is, the case of the antenna module 100 will be described. In this case, in addition to the normal direction of the dielectric substrate 130, radio waves are radiated also in the negative Y-axis direction (see the broken-line frame)

Referring to FIG. 12(C), the case where the planar inverted-F antennas 190 are disposed at both ends of the dielectric substrate 130, that is, the case of the antenna module 100A will be described. In this case, in addition to the normal direction of the dielectric substrate 130, radio waves are radiated also in the negative Y-axis direction and the positive Y-axis direction (see the broken-line frames). Therefore, according to the antenna module 100A related to the second embodiment, the coverage at both ends of the dielectric substrate 130 may be larger than that of the antenna module 100 related to the first embodiment.

FIG. 16 is a graph illustrating comparison among the simulation results in FIG. 12(A) to 12(C) in the form of cumulative distribution function (CDF). The first embodiment (FIG. 12(B)), the second embodiment (FIG. 12(C)), and the comparison example (FIG. 12(A)) are compared with each other by using the gain values approximately at 50% illustrated by a broken line in FIG. 16. In this case, as illustrated in FIG. 16, the first embodiment and the second embodiment have gain values higher than that of the comparison example. This result shows that, compared with the comparison example, the antenna module 100 according to the first embodiment and the antenna module 100A according to the second embodiment achieve increase in the coverage.

In addition, in the case of the antenna module 100A, the vacant area which is formed due to arrangement of the peripheral electrodes 150 at both ends of the dielectric substrate 130 and the peripheral electrodes 150 at both ends are utilized. Therefore, compared with the antenna module 100, while the antenna module 100A further utilizes the peripheral electrodes 150 and the vacant area of the dielectric substrate 130, the radiation coverage of radio waves may be increased. Like the antenna module 100 according to the first embodiment, the antenna module 100A according to the second embodiment is applied to the communication device 10.

### Third Embodiment

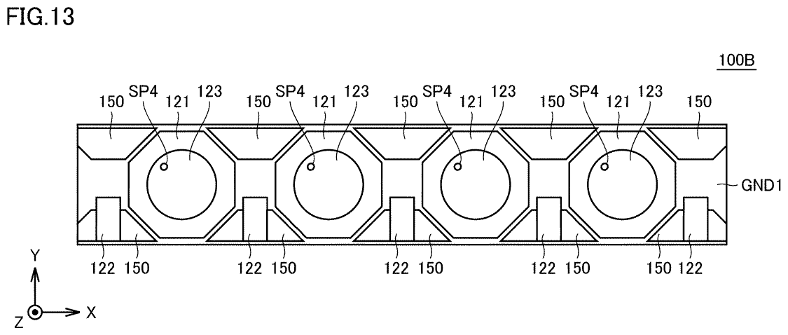

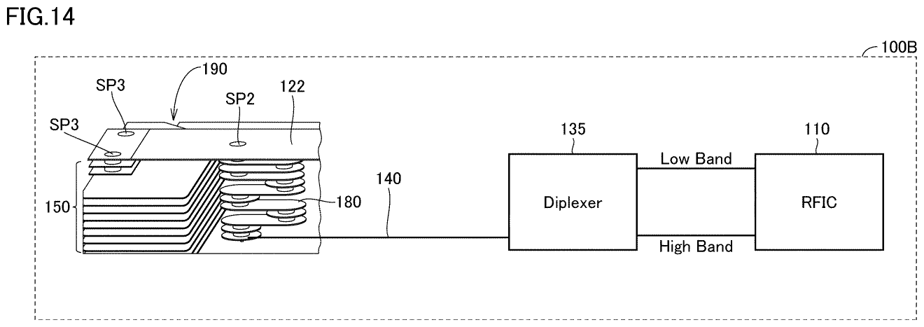

FIG. 13 is a plan view of the entire antenna module 100B related to a third embodiment. FIG. 14 is a diagram illustrating the configuration of feed lines of a second radiating element 122 in the antenna module 100B in FIG. 13. In the third embodiment, the antenna module 100B, which is a dual-band antenna, will be described.

As illustrated in FIG. 13, the antenna module 100B includes third radiating elements 123 in addition to the first radiating elements 121 and the second radiating elements 122. In this point, the antenna module 100B related to the third embodiment is different from the antenna module 100 related to the first embodiment. The antenna module 100A related to the second embodiment may include the third radiating elements 123 as illustrated in FIG. 13.

The third radiating elements 123 are stacked above the first radiating elements 121 with a dielectric layer interposed therebetween. The third radiating elements 123 are planar. In plan view in the normal direction of the dielectric substrate 130, the third radiating elements 123 are circular (e.g., each third radiating element 123 may overlap a corresponding first radiating element 121 in the lamination direction).

In the antenna module 100B, for example, the first radiating elements 121 are unfed elements; the third radiating elements 123 are fed elements. Feeding points SP4 of the third radiating elements 123 are disposed at the positions corresponding to the feeding points SP1 of the first radiating elements 121 related to the first embodiment. Feed wiring lines from the RFIC 110 extend through the first radiating elements 121, which are unfed elements, and are connected to the feeding points SP4.

The size in the polarization direction of the third radiating elements 123 is less than that in the polarization direction of the first radiating elements 121. Therefore, the resonant frequency of the third radiating elements 123 is higher than that of the first radiating elements 121.

When a radio frequency signal corresponding to the resonant frequency of the first radiating elements 121 is supplied from the RFIC 110 to a feeding point SP4, radio waves in a first frequency band corresponding to the resonant frequency are radiated from the first radiating element 121. When a radio frequency signal corresponding to the resonant frequency of the third radiating elements 123 is supplied from the RFIC 110 to a feeding point SP4, radio waves in a second frequency band corresponding to the resonant frequency are radiated from the third radiating element 123. The first frequency band may be, for example, 28 GHz. In this case, the second frequency band may be, for example, 39 GHz.

The size in the Y-axis direction of the second radiating elements 122 has been adjusted so that the frequency band of radio waves radiated from the first radiating elements 121 and the frequency band of radio waves radiated from the third radiating elements 123 are covered.

As illustrated in FIG. 14, the feed wiring line 140 of each of the second radiating elements 122 is connected to a diplexer 135. The RFIC 110 selectively transmits, to the diplexer 135, a radio frequency signal corresponding to the resonant frequency of the first radiating elements 121 and a radio frequency signal corresponding to the resonant frequency of the third radiating elements 123. A radio frequency signal corresponding to the resonant frequency of the first radiating elements 121 is a low band signal; a radio frequency signal corresponding to the resonant frequency of the third radiating elements 123 is a high band signal.

The diplexer 135 includes a filter circuit passing a radio frequency signal corresponding to the resonant frequency of the first radiating elements 121, and a filter circuit passing a radio frequency signal corresponding to the resonant frequency of the third radiating elements 123.

When a radio frequency signal corresponding to the resonant frequency of the first radiating elements 121 is supplied from the RFIC 110 through the diplexer 135 to a feeding point SP2, radio waves in the first frequency band are radiated from the second radiating element 122. When a radio frequency signal corresponding to the resonant frequency of the third radiating elements 123 is supplied from the RFIC 110 through the diplexer 135 to a feeding point SP2, radio waves in the second frequency band are radiated from the second radiating element 122. In the above embodiment, the example of single-feed type in which a low band signal and a high band signal are supplied through the diplexer 135 to a feeding point SP2 is described. However, when dual-feed type is employed in which a low band signal and a high band signal are individually supplied to the second radiating element 122, the diplexer 135 is not required.

As described above, the antenna module 100B is capable of radiating radio waves in two different frequency bands. Like the antenna module 100 according to the first embodiment, the antenna module 100B according to the third embodiment is applied to the communication device 10. In the third embodiment, the first radiating elements radiate radio waves in the first frequency band (for example, 28 GHz); the third radiating elements 123 radiate radio waves in the second frequency band (for example, 39 GHz) which is higher than the first frequency band (for example, 28 GHz). The first radiating elements 121 are disposed in a layer between the third radiating elements 123 and the ground electrode GND1. The antenna module 100B includes the RFIC 110 which feeds power to the third radiating elements 123. The RFIC 110 is an example of a feeding circuit.

### Modified Example

In the embodiments, the planar inverted-F antennas 190 are described as an example of inverted-F antennas included in an antenna module. Instead of planar inverted-F antennas, rod-shaped inverted-F antennas may be employed. In other words, the second radiating elements 122 may be rod-shaped elements, instead of planar elements.

As an example of the first radiating elements 121, octagon-shaped elements are described; as an example of the third radiating elements 123, circular elements are described. However, the first radiating elements 121 and the third radiating elements 123 may have any shape as long as they are planar.

As an example of the peripheral electrodes 150, trapezoidal electrodes are described. However, the shape of the peripheral electrodes 150 may have any shape, such as rectangle or circle.

In the third embodiment, the example in which the first radiating elements 121 are unfed elements and in which the third radiating elements 123 are fed elements is described. However, the first radiating elements 121 may be fed elements; the third radiating elements 123 may be unfed elements. Alternatively, the first radiating elements 121 and the third radiating elements 123 may be fed elements.

### Aspects

It is to be understood by those skilled in the art that the above embodiments are concrete examples of the following aspects.

### (First Aspect)

An antenna device according to an aspect includes a rectangular dielectric substrate that includes a plurality of laminated dielectric layers and that has two pairs of opposite sides; at least one first radiating element formed in or on the dielectric substrate; at least one second radiating element disposed adjacent to the at least one first radiating element in a first direction, the first direction being orthogonal to a lamination direction of the dielectric substrate and being parallel to one of the two pairs of opposite sides; a ground electrode disposed opposite the at least one first radiating element and the at least one second radiating element; and at least one peripheral electrode that is formed in a plurality of layers between the at least one first radiating element and the ground electrode, and that is electrically connected to the ground electrode and the at least one second radiating element. In plan view of the dielectric substrate in the lamination direction, a first end portion of the at least one second radiating element is an open-circuited end, the first end portion being an end portion closer to a median line of the dielectric substrate among portions on both end portions of the at least one second radiating element in a second direction, the median line equally dividing the dielectric substrate in the first direction, the second direction being orthogonal to the lamination direction and the first direction.

### (Second Aspect)

In the antenna device according to the first aspect, the at least one first radiating element includes two first radiating elements disposed side by side in the first direction. The at least one second radiating element is disposed between the two first radiating elements.

### (Third Aspect)

In the antenna device according to the first or second aspect, in plan view of the dielectric substrate in the lamination direction, the at least one peripheral electrode includes two peripheral electrodes disposed opposite each other in the second direction. The at least one second radiating element is disposed above each of the two peripheral electrodes.

### (Fourth Aspect)

In the antenna device according to the first or second aspect, the at least one second radiating element is connected to the at least one peripheral electrode in a second end portion opposite the first end portion.

### (Fifth Aspect)

In the antenna device according to any one of the first to fourth aspects, the at least one first radiating element radiates a radio wave in a first frequency band. The antenna device further includes a third radiating element that is disposed for each of the at least one first radiating element, and that radiates a radio wave in a second frequency band higher than the first frequency band; and a feeding circuit electrically connected to the third radiating element. The at least one first radiating element is disposed in a layer between the corresponding third radiating element and the ground electrode. The feeding circuit selectively outputs a first radio frequency signal corresponding to the first frequency band and a second radio frequency signal corresponding to the second frequency band.

### (Sixth Aspect)

An antenna module includes the antenna device according to any one of the first to fifth aspects; and a feeding circuit.

### (Seventh Aspect)

A communication device includes the antenna module according to the sixth aspect.

It is to be understood that the embodiments disclosed in this specification are exemplary in all points and are not limited. It is to be intended that the scope of the present disclosure is defined by the scope of claims, not by the description of the above embodiments, and encompasses all changes within the meaning and scope equivalent to the scope of claims.

### REFERENCE SIGNS LIST

10 communication device
100, 100A, 100B antenna module
110 RFIC
111A to 111D, 113A to 113D, 117 switch
112AR to 112DR low-noise amplifier
112AT to 112DT power amplifier
114A to 114D attenuator
115A to 115D phase shifter
116 signal combiner/splitter
118 mixer
119 amplifier circuit
120 antenna device
121 first radiating element
122 second radiating element
122a first end portion
122b second end portion
123 third radiating element
130 dielectric substrate
131 upper surface
132 lower surface
140, 141 feed wiring line
150 peripheral electrode
151, 181 via
160 solder bump
170 wiring pattern
180 power-feeding electrode
190 planar inverted-F antenna
200 BBIC
1000 SiP module
1010 power module IC
1020 power inductor
CP surface center
GND1, GND2 ground electrode
SP1, SP2, SP4 feeding point
SP3 short-circuit point

1. An antenna device, comprising:
a rectangular dielectric substrate that includes a plurality of laminated dielectric layers, the dielectric substrate having two pairs of opposite sides;
at least one first radiating element in or on the dielectric substrate;
at least one second radiating element adjacent to the at least one first radiating element in a first direction, the first direction being orthogonal to a lamination direction of the dielectric substrate and being parallel to one of the two pairs of opposite sides;
a ground electrode opposite the at least one first radiating element and the at least one second radiating element; and
at least one peripheral electrode between the at least one first radiating element and the ground electrode, the at least one peripheral electrode being electrically connected to the ground electrode and to the at least one second radiating element,
wherein, in a plan view of the dielectric substrate in the lamination direction, a median line of the dielectric substrate extends along the first direction, the median line equally dividing the dielectric substrate,
wherein the at least one second radiating element includes a first end portion and a second end portion opposite each other along a second direction, the second direction being orthogonal to the lamination direction and the first direction, and
wherein, in the plan view of the dielectric substrate in the lamination direction, the first end portion of the at least one second radiating element is an open-circuited end, the first end portion being closer to the median line than the second end portion is in the second direction.

2. The antenna device according to claim 1,
wherein the at least one first radiating element includes two first radiating elements adjacent to each other in the first direction, and
wherein the at least one second radiating element is between the two first radiating elements.

3. The antenna device according to claim 1,
wherein, in the plan view of the dielectric substrate in the lamination direction, the at least one peripheral electrode includes two peripheral electrodes opposite each other in the second direction, and
wherein the at least one second radiating element is above each of the two peripheral electrodes.

4. The antenna device according to claim 1,
wherein the second end portion of the at least one second radiating element is connected to the at least one peripheral electrode.

5. The antenna device according to claim 1,
wherein the at least one first radiating element is configured to radiate a radio wave in a first frequency band,
wherein the antenna device further comprises:
a third radiating element above each of the at least one first radiating element, the third radiating element being configured to radiate a radio wave in a second frequency band higher than the first frequency band; and
a feeding circuit electrically connected to the third radiating element,
wherein the at least one first radiating element is in a layer between a corresponding third radiating element and the ground electrode, and
wherein the feeding circuit is configured to selectively outputs a first radio frequency signal corresponding to the first frequency band and a second radio frequency signal corresponding to the second frequency band.

6. The antenna device according to claim 1,
wherein the at least one peripheral electrode is between the ground electrode and the at least one second radiating element in the lamination direction, and
wherein the at least one second radiating element is between the at least one peripheral electrode and the at least one first radiating element in the lamination direction.

7. The antenna device according to claim 1,
wherein the at least one second radiating element overlaps a top of the at least one peripheral electrode, as viewed in the plan view of the dielectric substrate in the lamination direction.

8. The antenna device according to claim 7,
wherein the at least one second radiating element has a linear shape in the second direction, as viewed in the plan view of the dielectric substrate in the lamination direction, and
wherein the first end portion of the at least one second radiating overhangs the at least one peripheral electrode in the second direction.

9. The antenna device according to claim 1,
wherein the at least one first radiating element and the at least one second radiating element have a non-overlapping relationship in the lamination direction.

10. An antenna module, comprising:
the antenna device according to claim 1; and
a feeding circuit.

11. A communication device comprising the antenna module according to claim 10.
